(19) United States
(12) Patent Application Publication
(10) Pub. No.: US 2008/0048157 A1
(43) Pub. Date: Feb. 28, 2008

(54) Scorch prevention in flexible polyurethane foams

(76) Inventors: Samuel Bron, Rehovot (IL); Ariel Sluszny, Kiryat Ata (IL); Dorit Peled, Haifa (IL); Dorit Perle, Haifa (IL); Mark Gelmont, Nesher (IL); Orly Cohen, Kiryat Ata (IL); Avi Ben-Zvi, Meitar (IL); Michael Peled, Beer-Sheva (IL); Ron Frim, Haifa (IL)

Correspondence Address: Kevin D. McCarthy;Roach Brown McCarthy & Gruber, P.C., 420 Main Street, 1620 Liberty Building, Buffalo, NY, 14202, US

(21) Appl. No.: 11/643,461

(22) Filed: Dec. 21, 2006

Related U.S. Application Data
(63) Continuation-in-part of application No. 10/588,398.
Application No. 10/588,398 is a continuation-in-part of application No. PCT/IL05/00554, filed on May 30, 2005.

(30) Foreign Application Priority Data
Jun. 10, 2004 (IL) 162450

(51) Int. Cl. C09K 21/12; C08G 18/00

(52) U.S. Cl. 252/609; 522/76

(57) ABSTRACT

Compositions and methods for alleviating or preventing discoloration in flame-retarded flexible polyurethane foams, known as “scorching”, are provided. The anti-scorch compositions contain antioxidant agents combined with at least one, and preferably with two, additional compounds selected from β-diketone compounds, epoxy compounds, organic phosphites or phosphonites, and metal salts of carboxylic acids.

### CLAIM OF PRIORITY

This application claims priority as (1) a continuation-in-part of U.S. patent application Ser. No. 10/588,398 submitted to the USPTO on Aug. 3, 2006, which claims priority to (a) as a continuation-in-part of international application number PCT/IL2005/000554, filed on May 30, 2005; and (b) Israeli patent application number 162450, filed on Jun. 10, 2004 and (2) Israeli patent application number ______, filed on Dec. 20, 2006 (Attorney ref. no. 21755/fr/06).

### FIELD OF THE INVENTION

The present invention relates to the prevention of discoloration in flexible polyurethane foams, a phenomenon commonly referred to as “scorching”. More particularly, the invention relates to novel compositions useful to alleviate or prevent the aforementioned undesirable effect.

### BACKGROUND OF THE INVENTION

Scorching is an undesirable discoloration phenomenon which occurs within polyurethane (PU) foam blocks, causing them to assume a yellow to brown color. This discoloration is especially apparent in the center of the blocks where the internal temperatures remain high for a relatively long period of time. The exposure of the interior of the foams to high temperatures leads to embrittlement and the core discoloration commonly known as scorching. In severe cases, it can cause a degradation of physical properties or, where scorching is particularly intense, it can result in spontaneous combustion of freshly made foam blocks. Flame retardants (FR), with few exceptions, exacerbate the “scorch” problems that arise during processing of PU foams. Flame retardants create several problems for the manufacturers of water-blown, flexible, slab stock foams, including increased “scorch” during processing and increased smoldering tendency of foams subjected to the California TB 117 standard.

The use of antioxidants has been proposed in the art and it can mitigate to some extent the evolution of scorch, and discoloration in flame retarded polyols and PU foams. However, the antioxidants by themselves are not enough efficient in preventing the problem of scorch existing during the manufacture of flexible polyurethane foams. WO2005/121248 disclosed an anti-scorch composition comprising, beside an antioxidant, metal salts of organic acids and an epoxy compound. U.S. patent application Ser. No. 10/588,398 of the present inventors relates to an anti-scorch composition comprising an organic phosphite beside an antioxidant, an epoxy compound, and metal salts of organic acids.

It is an object of the present invention to provide novel anti-scorch compositions that efficiently addresses the problem of scorch for flexible polyurethane formulations flame retarded with scorch-inducing FR such as phosphorus-based FR or halogen-containing FR, whether aliphatic or aromatic halogenated FR, or their combination.

It is still another object of the invention to provide an anti-scorch combination that overcomes the drawbacks of the prior art.

It is also an object of the invention to mitigate the problem of scorching and to enable greater versatility during the manufacture of polyurethane foams.

It is yet another object of the invention to provide a method for preventing or diminishing the occurrence of scorch during the manufacturing of flexible polyurethane foams.

Other purposes and advantages of the invention will become apparent as the description proceeds.

### SUMMARY OF THE INVENTION

The invention is directed to an anti-scorch composition for flame-retarded flexible polyurethane (PU) foams, comprising at least one antioxidant agent, and at least one, and preferably at least two, additional compound(s) selected from compounds comprised in the following compound-groups: β-diketone compounds, heavy metal salts of carboxylic acids, epoxy compounds, and organic phosphorous-based reducing agents. Said antioxidant agent is understood not to be identical to any of said additional compounds. Illustrative and non-limitative examples of antioxidant agents are phenols and amino oxygen scavengers, such as hindered phenols. Illustrative and non-limitative examples of aminic oxygen scavengers include alkylated diphenylamines. Said at least one antioxidant agent may comprise a mixture of hindered phenol and an alkylated diphenylamine. A non-limitative example of a β-diketone compound suitable for use in the composition of the invention is dibenzoylmethane, 2,4-pyrimidinedione, stearoylbenzoyl-methane, and dehydroacetic acid.

According to a preferred embodiment of the invention, the anti-scorch composition for flame-retarded PU foams comprises, beside an antioxidant agent, also a β-diketone compound and a salt of a carboxylic acid, which acid may be selected from among saturated or unsaturated, aliphatic or aromatic, mono- or di-carboxylic acids. Preferably, according to another preferred embodiment of the invention the salt of the organic acid is a heavy metal salt, for example comprising of Ca, Mg, Zn, Ba or Sn. An illustrative example of said salts may include barium oleate, barium t-butylbenzoate, barium ethylhexanoate, zinc t-butylbenzoate, calcium dimethyl ethylbenzoate, etc.

According to another preferred embodiment of the invention, the anti-scorch composition for flame-retarded PU foams comprises, beside an antioxidant agent, also a β-diketone compound and a phosphorous-based organic reducing agent such as phosphite or phosphonite. Said phosphite may be selected from, without being limited to, tris(alkylphenyl)phosphites, trialkyl phosphites, dialkyl phenyl phosphites, triphenyl phosphites, and alkyl diphenyl phosphites.

According to still another preferred embodiment of the invention, the anti-scorch composition for flame-retarded PU foams comprises, beside an antioxidant agent, also a β-diketone compound and an epoxy compound. Said epoxy compound may be selected from among diglycidyl ether of bisphenol A and its derivatives. Said epoxy compound has available epoxy groups, i.e., epoxy groups essentially not neutralized by previous curing.

According to a further preferred embodiment of the invention, the anti-scorch composition for flame-retarded PU foams comprises, beside an antioxidant agent, also a phosphorous-based organic reducing agent such as phosphite or phosphonite, and optionally also another component selected from a salt of a carboxylic acid, a β-diketone compound, and an epoxy compound, preferably a salt of a carboxylic acid, which acid may be selected from among saturated or unsaturated, aliphatic or aromatic, mono- or di-carboxylic acids.

According to a still further preferred embodiment of the invention, the anti-scorch composition for flame-retarded PU foams comprises, beside an antioxidant agent, also an epoxy compound and another component selected from a phosphorous-based organic reducing agent and a salt of a carboxylic acid.

The invention provides anti-scorch compositions comprising at least one antioxidant agent together with at least one, and preferably at least two, additional compounds selected from the following compound families: β-diketone compounds, heavy metal salts of carboxylic acids, epoxy compounds, and organic phosphorous-based reducing agents. In a particularly preferred embodiment of the invention, said additional compounds are selected from different compound families, preferably each additional compound is selected from a different compound family. In other preferred embodiment of the invention, the anti-scorch composition comprises at least one antioxidant agent together with at least one β-diketone compound, and with at least two additional compounds selected among heavy metal salts of carboxylic acids and epoxy compounds, and organic phosphorous-based reducing agents. In still another preferred embodiment of the invention, the anti-scorch composition comprises at least one antioxidant agent together with at least one organic phosphorous-based reducing agent, and preferably also with at least one or at least two additional compounds selected among heavy metal salts of carboxylic acids, and epoxy compounds.

The invention relates to anti-scorch compositions for flame-retarded flexible polyurethane (PUI foams, which foams may be retarded by any FR known in the art. In one aspect, the foams are retarded by a flame-retardant (FR) comprising aliphatic or aromatic, phosphorus-based, flame retardants. In another aspect of the invention, the flexible polyurethane (PU) foams are retarded by a FR comprising a halogen-containing flame retardant. Said PU foams may comprise an aliphatic or aromatic, brominated or chlorinated, FR. Said halogen-containing flame retardant may be selected from the group consisting of tribromoneopentyl alcohol, tris(2-chloroisopropyl)phosphate, tris(dichloropropyl)phosphate, chlorinated alkyl phosphate ester, halogenated aryl esters/aromatic phosphate blend, pentabromobenzyl alkyl ethers, brominated epoxy, alkylated triphenyl phosphate ester, and mixtures thereof.

The invention provides a method for preventing or diminishing scorch in a flame-retarded flexible polyurethane foam, comprising adding to the polyurethane composition, prior to foaming, at least one antioxidant agent, and at least one, and preferably at least two, compound(s) selected from the group of compounds comprising β-diketone compounds, heavy metal salts of carboxylic acids, epoxy compounds, and organic phosphorous-based reducing agents. In a preferred embodiment, several compounds are selected from several of said groups of compounds, comprising, for example, two or three or four different compounds from two or three or four different groups, in addition to said antioxidant agent. Said agent and said compounds may be added separately, in any order, or they may be added in mixtures, possibly in mixtures with other components used during the manufacture of said PU foams, comprising polyols, FRs, solvents, or other reagents or additives introduced to the formulation. In a method of the invention, the PU composition may further comprise stabilizers and additives used in the art for improving the foam properties, such as materials increasing stability and reducing the amounts of volatile species, and materials improving color and mechanical properties.

Said antioxidant agent(s) is selected from among phenols and amino oxygen scavengers, wherein the phenol may be a hindered phenol, said oxygen scavenger being possibly alkylated diphenylamine. In a preferred embodiment, said at least one antioxidant agent comprises a mixture of hindered phenol and an alkylated diphenylamine. Said carboxylic acids may be selected from among saturated or unsaturated acids, aliphatic or aromatic acids, and monocarboxylic or dicarboxylic acids, said heavy metals may be selected from the group consisting of Ca, Mg, Zn, Ba, and Sn. In a method according to the invention, said β-diketone may be selected, for example, from among dibenzoylmethane, 2,4-pyrimidinedione, stearoylbenzoylmethane, and dehydroacetic acid. Said organic phosphorous-based reducing agents may be, for example, selected from the group consisting of tris(alkylphenyl)phosphites, trialkyl phosphites, dialkyl phenyl phosphites, triphenyl phosphites, and alkyl diphenyl phosphites. In a method according to the invention, the flame-retardant (FR) in said flame-retarded foams may comprise an aliphatic or aromatic, phosphorus-based, flame retardant, or said FR may comprise halogen-containing flame retardant. A method according to the invention may comprise an aliphatic or aromatic, brominated or chlorinated, FR. Said FR may be selected from the group consisting of tribromoneopentyl alcohol, tris(2-chloroisopropyl)phosphate, tris(dichloropropyl)phosphate, chlorinated alkyl phosphate ester, halogenated aryl esters/aromatic phosphate blend, pentabromobenzyl alkyl ethers, brominated epoxy, alkylated triphenyl phosphate ester, and mixtures thereof.

The above and other objects and advantages of the invention will be better understood from the following illustrative and non-limitative examples.

### EXAMPLES 1-15

Microwave (MW) Test Protocol for Scorch Evaluation

The test method consists of the following steps:

1. Foam production in a small shoe box with a square cross-section.

2. Immediately after the foam rise is complete (usually less than 2 minutes), the foam is heated using a microwave (MW) oven using a predetermined time and power level.

3. The foam is then heated in an oven at 120±20° C. for 2 min.

4. The foam is allowed to cure at RT (room temperature) for an additional 15 min.

5. By the end of the RT curing time the foam is cut (usually vertically) and the scorch is observed.

Scorch Evaluation

The scorch is evaluated using two methods:

1. The foam is photographed using a digital camera. This allows for a visual comparison between the scorch of a reference formulation and the scorch of the formulation under investigation.

2. The foam color is analyzed using a spectrophotometer. The results are expressed in the usual color space: L*a*b and performed accordingly to ASTM D-2244.

Note: The scorch intensity may change from day to day according to the physical conditions of the surroundings in which the foam has been prepared (usually the temperature and relative humidity). This is why it is customary to prepare each day a reference sample.

Foam Preparation

The mixture was prepared in a 0.65 l disposable cup. The components were added one at a time starting with the polyol. The mixture was vigorously mixed at 3500 rpm for 10 seconds following the addition of each component, not including the toluene diisocyanate (TDI). After the addition of TDI, the mixture was mixed for an additional 10 sec and then poured into a 25×25×17 cm cardboard box. The times between the TDI addition and the pouring into the cardboard box and the end of the foam blowing (rise time) were monitored.

Comparative Samples and Results

The effect of the antiscorching ingredients and their combinations was measured on the darkest areas on the foam after microwave oven treatment, using a spectrophotometer which provides color measurements expressed in the L*a*b color space. The most relevant color parameters for scorch assessment are Δb and ΔE.

The color parameters are given as normalized values relative to the reference specimens. As explained in the MW oven procedure, this particular method for scorch propensity assessment requires that a new reference foam be prepared, subjected to MW oven procedure and measured in each and every day of measurements. This requirement is related to the effect various experimental conditions, such as the temperature and the relative humidity of the air in the lab may have on the level of scorch. The normalized Δb and ΔE differences between a reference foam (containing no antiscorching ingredients) and foams containing various ingredients with antiscorch effects, are calculated as follows:

$$ΔΔ b ( normalized ) = \frac{Δ b ( reference ) - Δ b ( sample )}{Δ b ( reference )} \cdot 100$$

$$ΔΔ E ( normalized ) = \frac{Δ E ( reference ) - Δ E ( sample )}{Δ E ( reference )} \cdot 100$$

Note: A value greater than 100 can sometimes emerge from these calculations since both Δb and ΔE for each specimen are compared to a factory white standard. The higher the ΔΔb and ΔΔE values, the lower the scorch.

Formulations for two grades of foams are shown in Tables I and II: Medium density foams (Table I) have a density of approximately 25 kg/m³; Low density foams (Table II) have a density of approximately 15 kg/m³. The component amounts in tables I, II, IV, V, VI and VII are expressed as weight parts relative to 100 weight parts of polyol.

Ingredients: AO1 and AO5 are antioxidants produced by Goldschmidt (Degussa) and contain combinations of hindered phenols and aromatic diamines.

Epoxy 828 is diglycidyl ether of bisphenol A (DGEBA).

ESBO is epoxidized soya bean oil.

All other ingredients below the FR-513 line in the table are metallic salts (Ca, Zn, Ba, Sn) of organic acids, and organic phosphites.

TABLE I
Anti-scorch performance of medium density foams

| | 1 | 2 | 3 | 4 | 5 | 6 | 7 | 8 | 9 |
|---|---|---|---|---|---|---|---|---|---|
| Polyol | 100 | 100 | 100 | 100 | 100 | 100 | 100 | 100 | 100 |
| Water | 4.2 | 4.2 | 4.2 | 4.2 | 4.2 | 4.2 | 4.2 | 4.2 | 4.2 |
| Silicon 8228 | 1.1 | 1.1 | 1.1 | 1.1 | 1.1 | 1.1 | 1.1 | 1.1 | 1.1 |
| Amine Dabco 33LV | 0.09 | 0.09 | 0.09 | 0.09 | 0.09 | 0.09 | 0.09 | 0.09 | 0.09 |
| Amine BDE | 0.03 | 0.03 | 0.03 | 0.03 | 0.03 | 0.03 | 0.03 | 0.03 | 0.03 |
| Tin T-9 | 0.25 | 0.25 | 0.25 | 0.25 | 0.25 | 0.25 | 0.25 | 0.25 | 0.25 |
| Toluene di-isocyanate | 56.31 | 56.31 | 56.31 | 56.31 | 56.31 | 56.31 | 56.31 | 56.31 | 56.31 |
| (TDI) | | | | | | | | | |
| FR-513 | 5 | 5 | 5 | 5 | 5 | 5 | 5 | 5 | 5 |
| AO5 | 0.42 | 0.21 | 0.85 | | | | | | |
| Calcium stearate | 0.42 | 0.21 | | | | | | | |
| (CaSt) | | | | | | | | | |
| PK4610 | 0.42 | 0.21 | | | | | | | |
| Epoxy 828 | | | 0.85 | | 0.1 | 0.1 | 0.21 | | |
| ESBO | | | | 1.7 | | | | | |
| LZB 138 | | | | | 0.21 | | | 0.21 | 0.21 |
| AO 1 | | | | | 0.21 | 0.21 | 0.21 | 0.21 | 0.21 |
| CZ400 | | | | | | 0.21 | | 0.21 | |
| CZ 118 S | | | | | | | 0.21 | | 0.21 |
| ΔΔb | 90.13 | 106.1 | 49.17 | −132.6 | 82.32 | 77.06 | 93.93 | 84.58 | 102.9 |
| ΔΔE | 17.04 | 10.84 | 18.34 | −99.43 | 27.61 | 32.67 | 30.14 | 37.42 | 33.98 |

TABLE II
Anti-scorch performance of low density foams

| | 10 | 11 | 12 | 13 | 14 | 15 |
|---|---|---|---|---|---|---|
| Polyol | 100 | 100 | 100 | 100 | 100 | 100 |
| Water | 5.25 | 5.25 | 5.25 | 5.25 | 5.25 | 5.25 |
| Silicon 8228 | 1.0 | 1.0 | 1.0 | 1.0 | 1.0 | 1.0 |
| Amine | 0.06 | 0.06 | 0.06 | 0.06 | 0.06 | 0.06 |
| Dabco 33LV | | | | | | |
| Amine BDE | 0.046 | 0.046 | 0.046 | 0.046 | 0.046 | 0.046 |
| Tin T-9 | 0.37 | 0.37 | 0.37 | 0.37 | 0.37 | 0.37 |
| Methylene | 11 | 11 | 11 | 11 | 11 | 11 |
| chloride | | | | | | |
| (MeCl) | | | | | | |
| TDI | 71.1 | 71.1 | 71.1 | 71.1 | 71.1 | 71.1 |
| FR-513 | 15 | 15 | 15 | 15 | 15 | 15 |
| AO5 | | | 0.1 | 0.3 | | 0.2 |
| Epoxy 828 | 0.5 | 1.0 | | | | |
| BM270 | | | | | 1.0 | 0.2 |
| LZB287 | | | | | | 0.6 |
| ΔΔb | −14.11 | 24.37 | −15.10 | −77.1 | 95.29 | 50.90 |
| ΔΔE | 0 | 13.73 | −10.13 | −41.03 | 27.80 | 11.70 |

TABLE III
Composition of ingredients used in antiscorch materials.

| Producer | Name | Ingredients | | State |
|---|---|---|---|---|
| Akcros | Lankromark | 1) Barium oleate | 40% | Liquid |
| | LZB287 | Barium t-butylbenzoate | | |
| | | 2) Zinc 2-ethylhexanoate | 5-10% | |
| | | 3) Phosphite esters | 20-40% | |
| | | 4) 2-(2-butoxyethoxy)ethanol | 5-10% | |
| | | 5) Phenol | 5-10% | |
| | Lankromark | 1) Barium 2-ethylhexanoate | 20% | Liquid |
| | LZB413 | Barium oleate | | |
| | | Barium t-butylbenzoate | | |
| | | 2) Zinc 2-ethylhexanoate | 1-5% | |
| | | 3) Zinc t-butylbenzanoate | 1-5% | |
| | | 4) Phosphite esters | 20-40% | |
| | | 5) Trisnonylphenyl phosphite | 1-5% | |
| | | 6) 2-(2-butoxyethoxy ethanol) | | |
| | Lankromark | 1) Barium compounds | 2-15 | Liquid |
| | LZB138 | (% as barium metal | | |
| | | 2) Zinc 2-ethylhexanoate | 10-20% | |
| | | 3) Phosphite esters | 20-40% | |
| | | 4) 2-(2-butoxyethoxy) ethanol | 5-10% | |
| | | 5) Phenol | 1-5% | |
| | Lankroflex | 1) Epoxidized soya bean oil | >99% | Liquid |
| | E2307 | | | |
| | Tinstab BTS71S | 1) n-Butyltin tris (2-ethylhexylthio- | ˜20% | Liquid |
| | | glycolate) | | |
| | | 2) Di-n-butyltin bis (2-ethylhexylthio- | ˜70% | |
| | | glycolate) | | |
| | Tinstab BM270 | 1) Di-n-butyltin bis (methylmaleate) | ˜95% | Liquid |
| Shell | Epoxy 828 | | ˜100% | Liquid |
| Chemson | Naftosafe | Ca/Zn organic stabilizer | — | Powder |
| Group | PK4610 | | | |
| Gold- | Ortegol AO1 | Steric hindered phenol derivate | 66.7% | |
| schmidt | | Alkylated diphenylamine | 33.3% | |
| | Ortegol AO5 | Steric hindered phenol derivate | 70-72% | |
| | | Alkylated diphenylamine | 20-22% | |
| Crompton | Mark CZ 400 | 2-(2-Butoxyethoxy)ethanol | <10% | Liquid |
| | (Ca/Zn stabilizer) | Alkylarylphosphites | 55-65% | |
| | | Calcium 4-(1,1-dimethylethyl)benzoate | <10% | |
| | Mark CZ 118S | Tris(nonylphenyl)phosphite | 30-40% | Liquid |
| | (Ca/Zn stabilizer) | Other components - not listed | | |
| | Mark BZ 592 | Solvent naphtha, light aromatic | <10% | Liquid |
| | (Ba/Zn stabilizer) | Barium compounds | 35-45% | |
| | | Triisodecyl phosphite | <25% | |
| Crompton | Mark BZ 562 | Solvent naphtha, light aromatic | <10% | Liquid |
| | (Ba/Zn | Alkylarylphosphites | 20-30% | |
| | stabilizer) | Zinc bis(p-nonylphenolate) | <3% | |
| | | Barium compounds | 35-45% | |
| | ark BZ 555 | Tris(2-ethylhexylmercaptoacetate) | 5-15% | Liquid |
| | (Ba/Zn | phosphate | | |
| | stabilizer) | Diisodecyl phenyl phosphite | 25-35% | |
| | | Solvent naphta, light aromatic | 5-15% | |
| | | Barium compounds | 20-30% | |
| | Mark BZ 563 | Diisodecyl phenyl phosphite | 30-50% | Liquid |
| | (Ba/Zn | 2-(2-Butoxyethoxy)ethanol | <5% | |
| | stabilizer) | Zinc bis(p-nonylphenolate) | <5% | |
| | | Barium compounds | 20-30% | |

From the results in Tables I and II it is clearly seen that the compositions of the invention attain a substantial improvement.

The notations and composition of materials used as antiscorch ingredients in the examples in Tables I and II are detailed in Table III.

Example 3 in Table I and Examples 12 and 13 in Table II, respectively, demonstrate that the use of a conventional antioxidant, i.e. a mixture of hindered phenols and alkylated diphenyldiamines, alone or together with an epoxy moiety, does not prevent scorch in a bromine-containing FR formulation. Epoxy alone, either as DGEBA or ESBO, are not effective either (Examples 4 in Table 1, and Examples 10 and 11 in Table II). However, addition of organic phosphites in combination with metallic salts of various organic acids, significantly improves the resistance to scorch of a polyurethane flexible foam formulation including a bromine-containing flame retardant (Examples 7 8, 9—Table I, and Examples 14, 15—Table II).

### EXAMPLE 16-25

MW Test Protocol for Scorch Evaluation

1. Foam production in a small shoe box with a square cross-section.

2. Immediately after the foam rise is complete (usually less than 2 minutes), the foam is heated in a microwave (MW) oven that is equipped with an electronic controlling circuit that controls the overall heating energy emitted by the MW oven. Controlling feedback is accomplished via measuring the temperature of a given constant mass of water co-heated alongside the foam. The water temperature closely follows a pre-set rate of temperature rise (ramp) over a predetermined period of time so that a constant temperature difference is maintained in each heating cycle.

3. The foam is then placed in an oven at 110-120° C. for 17 minutes not only to cure but also to slow down the foam's natural cooling and to isolate it from climate and surrounding changes as well. The foam's core temperature is being monitored throughout this stage with a k-type 1.6 mm diameter thermocouple plugged into a data-logger.

4. Following the 17 minutes curing the foam is sliced perpendicular to foam rise direction, obtaining square cross-section slices. The surface of the central slice is then photographed and its scorch level is evaluated.

Digital Scorch Evaluation

The effect of anti-scorching ingredients on various scorch-forming flame retardants in various common flexible polyurethane formulations was measured all over the surface of the central foam slice, where the foam core temperature was the highest along the disclosed procedure, rather than locally on selected darkest zones alone. Digital photographs taken under fully controlled parameters (illumination, filming angles) were processed by graphic software that scans the photographs having the same resolution and sums up the number of pixels having different colors over a selected slice area. The resulting value, Unique Colors (UC), highly correlates with the visual comparative inspection of scorch intensity. The UC values are straightforward, the lower there are the less scorched is the foam. A reduced UC value indicates a better anti-scorch effect.

Note: The controlled emission of the MW energy during the foam heating stage of the test procedure, together with the controlled and slowed down cooling of the foam that is isolated from the surrounding climate changes, were statistically proved to accomplish highly reproducible day-to-day results. Scanning to measure the entire scorched area also was well contributing to the accuracy and reproducibility of the test procedure. Nevertheless, often a reference formulation was carried as an internal test to assure that test parameters are fully kept and the resulting scorch intensity falls within the narrow variability limits of the procedure.

Foam Preparation

The foam mixture was prepared in a 0.65 l disposable cup. All components, but the water and the toluene di-isocyanate (TDI), were successively added starting with the polyol. The mixture was vigorously mixed at 4400 rpm for 15 seconds, followed by the injection of pre-weighed water under continuous mixing. Mixing was allowed for 20 seconds more before the pre-weighed TDI was introduced, followed by 10 seconds of further mixing and an immediate pouring of the mixture into a 25×25×17 cm³ cardboard box. Foam rise time, from pouring to blow-off, was recorded.

Various halogen-containing, phospho-halogenated and combinations of phosphated with halogenated common commercial flame retardants, among them some well known to be accompanied by an intense scorching process, were introduced into the foam formulations. The marked effect of the combination of the anti-scorching components was demonstrated by comparing the measured scorch intensity (UC values) with and without their presence in the formulation containing each of these flame retardants. These results and the medium density formulation (foam density ca. 25 kg/m³ in FR-513 containing foams) used with the various flame retardants—with the necessary changes of TDI—are presented in tables IV and V.

The efficacy of the same combination of anti-scorching components toward various halogen-containing and phospho-halogenated flame retardants is shown to be equally high for different foam formulations or foam densities, as presented in table VI.

A combination of anti-scorch ingredients according to the invention, comprising hindered phenol, alkylated diphenylamine, epoxy compound, and organic phosphites with or without metallic salts of organic acids, is demonstrated hereafter to effectively diminish or prevent the scorch occurrence within foams containing scorch-forming flame retardants, such as: halogenated—wherein the halogen is either aromatic or aliphatic—and/or halogenated phosphates—wherein the halogen is either aromatic or aliphatic- and/or phosphorus-based flame retardants. Illustrative and non-limitative examples of such flame retardants are: tribromoneopentyl alcohol (FR-513 ex Dead Sea Bromine Group, DSBG), tris(2-chloroisopropyl)phosphate (TCPP, Fyrol FR-2 ex Akzo Nobel), chlorinated alkylphosphate ester (Amgard V6 ex Albright and Wilson/Antiblaze V6 ex Albemarle), Halogenated aryl esters/Aromatic phosphate Blend (FM-550 ex Great Lakes), pentabromobenzyl alkyl ethers (FR-1435X ex DSBG), brominated epoxy F-3014 (ex DSBG) dissolved in phosphates (Phosflex 31L ex Akzo Nobel) 1:1 w/w, alkylated triphenyl phosphate ester (Phosflex 3 IL ex Akzo Nobel)

The selected combination of the anti-scorch ingredients comprises the materials:

AO5: Antioxidant produced by Goldschmidt (Degussa), containing a combination of hindered phenols and aromatic diamines, or equivalents such as IRGASTAB PUR 67 ex Ciba

Epoxy 828: EPON™ Resin 828 produced by Resolution Performance Products is diglycidyl ether of bisphenol A (DGEBA), or equivalents such as DER 331 Epoxy resin ex DOW.

Metallic (Ba, Zn, Ca or Sn) salts of organic acids and organic phosphites are included in non-commercial yet, under-development products.

TABLE IV
Anti-scorch performance of medium density foams with halogenated or phospho-halogenated flame retardants

| Ingredient | 16 | 16a | 17 | 17a | 18 | 18a | 19 | 19a | 19b | 20 | 20a | 21 | 21a |
|---|---|---|---|---|---|---|---|---|---|---|---|---|---|
| Flame | Fyrol FR-2 | | Amgard V6 | | F-3014 & | | FR-513 | | | FM 550 | | FR-1435X | |
| retardant | (TCPP) | | (Antiblaze V6) | | Phosphates | | | | | | | | |
| | 15 | | 10 | | 13 | | 8 | | | 14 | | 14 | |
| Polyol | 100 | | 100 | | 100 | | 100 | | | 100 | | 100 | |
| Silicon Niax | 0.95 | | 0.95 | | 0.95 | | 0.95 | | | 0.95 | | 0.95 | |
| L-650 | | | | | | | | | | | | | |
| Amine | 0.018 | | 0.018 | | 0.018 | | 0.018 | | | 0.018 | | 0.018 | |
| Dabco 33LV | | | | | | | | | | | | | |
| Amine BDE | 0.0624 | | 0.0624 | | 0.0624 | | 0.0624 | | | 0.0624 | | 0.0624 | |
| Tin T-9 | 0.153 | | 0.153 | | 0.153 | | 0.153 | | | 0.153 | | 0.153 | |
| Water | 4.63 | | 4.63 | | 4.63 | | 4.63 | | | 4.63 | | 4.63 | |
| Toluene di- | 62.03 | | 62.03 | | 62.53 | | 64.59 | | | 62.03 | | 62.03 | |
| isocyanate | | | | | | | | | | | | | |
| (Index 119) | | | | | | | | | | | | | |
| Anti-scorch | 0.0 | 1.0 | 0.0 | 1.0 | 0.0 | 1.0 | 0.0 | 1.0 | — | 0.0 | 1.0 | 0.0 | 1.0 |
| Combinat. 1^{a} | | | | | | | | | | | | | |
| Anti-scorch | | | | | | | | | 1.0 | | | | |
| Combinat. 2^{b} | | | | | | | | | | | | | |
| Scorch level | 23408 | 4927 | 43188 | 7777 | 28238 | 6134 | 27414 | 5640 | 5238 | 7111 | 5950 | 7806 | 5956 |
| (UC) | | | | | | | | | | | | | |
| Scorch | | −79 | | −82 | | −78 | | −79 | −81 | | −16 | | −24 |
| reduction, | | | | | | | | | | | | | |
| % | | | | | | | | | | | | | |

^{a}A combination of anti-scorch components that contains an anti-oxidant, epoxy, organic phosphites and metal salts of organic acids.
^{b}A combination of anti-scorch components that contains an anti-oxidant, epoxy and organic phosphites.

Sometimes phosphate esters are integrated with halogenated flame retardants to gain synergism in flame retardancy. Accordingly, the performance of a selected anti scorch combination—under the scope of the invention—is demonstrated in table V to reduce the scorch level when such FR combinations is used.

TABLE V
Anti-scorch performance of medium density foams with selected
combinations of halogenated and phosphated flame retardants

| | | | | |
|---|---|---|---|---|
| Ingredient | 22 | 22a | 23 | 23a |

| | | | |
|---|---|---|---|
| Flame | FR-513 | 3 | — |
| retardant | Phosflex | 3 | 4.5 |
| | 31L^{a} | | |
| | FR- | — | 4.5 |
| | 1435X | | |
| | Total FR | 6.0 | 9.0 |

| Polyol | 100 | | 100 | |
|---|---|---|---|---|
| Silicon Niax L-650 | 0.95 | | 0.95 | |
| Amine Dabco 33LV | 0.018 | | 0.018 | |
| Amine BDE | 0.0624 | | 0.0624 | |
| Tin T-9 | 0.153 | | 0.153 | |
| Water | 4.63 | | 4.63 | |
| Toluene di- | 64.75 | | 63.79 | |
| isocyanate | | | | |
| (Index 119) | | | | |
| Anti-scorch | 0.0 | 1.0 | 0.0 | 1.0 |
| Combinat. 2^{b} | | | | |
| Scorch level (UC) | 17090 | 5493 | 8982 | 7176 |
| Scorch reduction, % | — | −68 | — | −20 |

^{a}Phosflex 31L: Isopropylated triphenyl phosphate ester, ex. AKZO NOBEL
^{b}A combination of anti-scorch components that contains an anti-oxidant, epoxy, and organic phosphites.

An anti-scorch combination (AS package) selected among of those demonstrated in Tables IV and V is shown to maintain its high efficacy in diminishing or preventing scorching in foams containing scorch-forming flame retardants independently of the foam formulation, or the foam densities (e.g. medium—ca. 25 kg/m³ or low—ca. 15 kg/m³, in FR-513 containing foams). These results are presented in table VI.

TABLE VI
Anti-scorch performance of medium and low density formulations with different FRs

| | 24 | 24a | 25 | 25a | 26 | 26a | 27 | 27a |
|---|---|---|---|---|---|---|---|---|
| | Normal density foams - | | | | | | | |
| Ingredient | Second formulation | | | | Low density foams | | | |
| Flame | Fyrol FR-2 | | FR-513 | | Fyrol FR-2 | | FR-513 | |
| retardant | (TCPP) | | | | (TCPP) | | | |
| | 15 | | 6.5 | | 15 | | 8 | |
| Polyol | 100 | | 100 | | 100 | | 100 | |
| Silicon Niax L-650 | 1.1 | | 1.1 | | 1.0 | | 1.0 | |
| Amine Dabco 33LV | 0.09 | | 0.09 | | 0.06 | | 0.06 | |
| Amine BDE | 0.03 | | 0.03 | | 0.047 | | 0.047 | |
| Tin T-9 | 0.25 | | 0.25 | | 0.37 | | 0.37 | |
| MeCl₂ | — | | — | | 11.0 | | 11.0 | |
| Water | 4.20 | | 4.20 | | 5.25 | | 5.25 | |
| Toluene | 54.68 | | 56.67 | | 66.27 | | 68.72 | |
| diisocyanate | | | | | | | | |
| (Index 114) | | | | | | | | |
| Anti-scorch | 0.0 | 1.0 | 0.0 | 0.81 | 0.0 | 1.0 | 0.0 | 1.0 |
| Combinat. 1^{a} | | | | | | | | |
| Scorch level | 24537 | 4758 | 23667 | 5706 | 8159 | 5421 | 7910 | 4700 |
| (UC) | | | | | | | | |
| Scorch | | −81 | | −76 | | −34 | | −41 |
| reduction, | | | | | | | | |
| % | | | | | | | | |

^{a}A combination of anti-scorch components that contains an anti-oxidant, epoxy, organic phosphites and metal salts of organic acids.

Considering the background color measured over non-scorched areas, the selected anti-scorch package has been proved to significantly reduce and diminish scorch occurrence in flexible polyurethane foams containing scorch-forming flame retardants, independently of their formulation or density.

A clear improvement was also achieved in foams containing flame retardants that so far were considered by foam producers to produce an acceptable scorch level, such as the case of FM 550.

In a search for additional effective anti scorch reagents, several chemically defined β-diketones were tested. The anti-scorch performance of the more effective dibenzoylmethane is clearly noticed, as demonstrated in table VII.

TABLE VII
Anti-scorch performance of β-diketone in
a medium density formulation with FR-513

| | | | |
|---|---|---|---|
| Ingredient | 28 | 28a | 28b |

| | | |
|---|---|---|
| Flame | FR-513 | 8 |
| retardant | | |

| Polyol | 100 | | |
|---|---|---|---|
| Silicon Niax L-650 | 0.95 | | |
| Amine Dabco 33LV | 0.018 | | |
| Amine BDE | 0.0624 | | |
| Tin T-9 | 0.153 | | |
| Water | 4.63 | | |
| Toluene di- | 66.34 | | |
| isocyanate | | | |
| (Index 119) | | | |
| Anti-scorch | 0.38 | 0.38 | 0.38 |
| Combinat. 3^{a} | | | |
| Dibenzoyl methane | 0.0 | 0.45 | 0.0 |
| 2,4- | 0.0 | 0.0 | 0.52 |
| pyrimidinedione | | | |
| (uracil) | | | |
| Scorch level (UC) | 9937 | 6442 | 7155 |
| Scorch reduction, | — | −35 | −28 |
| % | | | |

^{a}A combination of anti-scorch components that contains an anti-oxidant and epoxy.

The scorch intensity, and the tendency to develop scorch as well, depend among other parameters on FR type and FRs combinations, on water level in the formulation, as well as on environmental parameters, further on the technology for foam production, and also on the slab stock size. The variety of anti scorch compositions of the invention provides a versatile, cost-effective, means for designing a tailor-made anti scorch combination for different conditions and for different PU foams.

All the above description has been provided for the purpose of illustration, and is not intended to limit the invention in any way. Various modifications can be carried out in the method and system according to the invention, without departing from its spirit.

1-22. (canceled)

23. An anti-scorch composition for flame-retarded flexible polyurethane foams, comprising at least one antioxidant agent, and at least one additional compound selected from P-diketone compounds, heavy metal salts of carboxylic acids, epoxy compounds, and organic phosphorous-based reducing agents.

24. An anti-scorch composition according to claim 23, comprising at least one antioxidant agent, and at least two additional compounds selected from the group consisting of P-diketone compound, heavy metal salt of carboxylic acid, epoxy compound, and organic phosphorous-based reducing agent.

25. A composition according to claim 23, wherein the antioxidant agent(s) is selected from among phenols and amino oxygen scavengers.

26. A composition according to claim 25, wherein the phenol is a hindered phenol.

27. A composition according to claim 25, wherein the amino oxygen scavenger is an alkylated diphenylamine.

28. A composition according to claim 25, wherein said at least one antioxidant agent comprises a mixture of hindered phenol and an alkylated diphenylamine.

29. A composition according to claim 23, wherein said β-diketone is selected from among dibenzoylmethane, 2,4-pyrimidinedione, stearoylbenzoyl-methane, and dehydroacetic acid.

30. A composition according to claim 23, wherein said carboxylic acids are selected from among saturated or unsaturated acids, aliphatic or aromatic acids, and monocarboxylic or dicarboxylic acids.

31. A composition according to claim 23, wherein said heavy metals are selected from the group consisting of Ca, Mg, Zn, Ba, and Sn.

32. A composition according to claim 23, wherein said epoxy compound is selected from among diglycidyl ether of bisphenol A and its derivatives.

33. An anti-scorch composition according to claim 23, wherein said organic phosphorous-based reducing agent is selected from phosphites and phosphonites.

34. A composition according to claim 33, wherein said organic phosphite is selected from the group consisting of tris(alkylphenyl)phosphites, trialkyl phosphites, dialkyl phenyl phosphites, triphenyl phosphites, and alkyl diphenyl phosphites.

35. A composition according to claim 23, wherein the flame retardant (FR) in said flame-retarded foams is an aliphatic or aromatic, phosphorus-based, flame retardant.

36. A composition according to claim 23, wherein the FR in said flame-retarded foams is a halogen-containing flame retardant.

37. A composition according to claim 36, wherein said FR is an aliphatic or aromatic, brominated or chlorinated, FR.

38. A composition according to claim 37, wherein said FR is selected from the group consisting of tribromoneopentyl alcohol, tris(2-chloroisopropyl)phosphate, tris(dichloropropyl)phosphate, chlorinated alkyl phosphate ester, halogenated aryl esters/aromatic phosphate blend, pentabromobenzyl alkyl ether, brominated epoxy, alkylated triphenyl phosphate ester, and mixtures thereof.

39. An anti-scorch composition according to claim 23, comprising at least one antioxidant agent, at least one β-diketone compound, and at least one additional compound selected from heavy metal salts of carboxylic acids, epoxy compounds, and organic phosphorous-based reducing agents.

40. An anti-scorch composition according to claim 23, comprising at least one antioxidant agent, at least one organic phosphorous-based reducing agent, and at least one additional compound selected from β-diketone compounds, heavy metal salts of carboxylic acids, and epoxy compounds.

41. A method for preventing or diminishing scorch in a flame-retarded flexible polyurethane foam, comprising adding to the polyurethane composition, prior to foaming, at least one antioxidant agent, and at least one or preferably at least two additional compounds, selected from β-diketone compounds, heavy metal salts of carboxylic acids, epoxy compounds, and organic phosphorous-based reducing agents.

42. A method according to claim 41, wherein said at least one agent and at least one or two compounds are added together with other reagents, used in the manufacture of said flame-retarded flexible polyurethane, selected from polyol(s), FR(s), and solvents.

43. A method according to claim 41, wherein the antioxidant agent(s) is selected from among phenols and amino oxygen scavengers.

44. A method according to claim 41, wherein the phenol is a hindered phenol.

45. A method according to claim 41, wherein the amino oxygen scavenger is an alkylated diphenylamine.

46. A method according to claim 41, wherein said at least one antioxidant agent comprises a mixture of hindered phenol and an alkylated diphenylamine.

47. A method according to claim 41, wherein said β-diketone is selected from among dibenzoylmethane, 2,4-pyrimidinedione, stearoylbenzoyl-methane, and dehydroacetic acid.

48. A method according to claim 41, wherein said carboxylic acids are selected from among saturated or unsaturated acids, aliphatic or aromatic acids, and monocarboxylic or dicarboxylic acids.

49. A method according to claim 41, wherein said heavy metals are selected from the group consisting of Ca, Mg, Zn, Ba, and Sn.

50. A composition according to claim 41, wherein said epoxy compound is selected from among diglycidyl ether of bisphenol A and its derivatives.

51. A method according to claim 41, wherein said organic phosphorous-based reducing agent is selected from phosphites and phosphonites.

52. A method according to claim 51, wherein said organic phosphite is selected from the group consisting of tris(alkylphenyl)phosphites, trialkyl phosphites, dialkyl phenyl phosphites, triphenyl phosphites, and alkyl diphenyl phosphites.

53. A method according to claim 41, wherein the flame-retardant (FR) in said flame-retarded foams is an aliphatic or aromatic, phosphorus-based, flame retardant.

54. A method according to claim 41, wherein the FR in said flame-retarded foams is a halogen-containing flame retardant.

55. A method according to claim 54, wherein said FR is an aliphatic or aromatic, brominated or chlorinated, FR.

56. A method according to claim 55, wherein said FR is selected from the group consisting of tribromoneopentyl alcohol, tris(2-chloroisopropyl)phosphate, tris(dichloropropyl)phosphate, chlorinated alkyl phosphate ester, halogenated aryl esters/aromatic phosphate blend, pentabromobenzyl alkyl ethers, brominated epoxy, alkylated triphenyl phosphate ester, and mixtures thereof.
